(19) United States
(12) Patent Application Publication
(10) Pub. No.: US 2020/0128859 A1
(43) Pub. Date: Apr. 30, 2020

(54) Wild Game Cooker

(71) Applicant: Chase Cook, Saratoga Springs, UT (US)

(72) Inventor: Chase Cook, Saratoga Springs, UT (US)

(21) Appl. No.: 16/667,626

(22) Filed: Oct. 29, 2019

Related U.S. Application Data
(60) Provisional application No. 62/751,793, filed on Oct. 29, 2018.

(51) Int. Cl. A23L 5/10; A47J 33/00; A23L 13/00; B65D 81/34

(52) U.S. Cl. CPC A23L 5/15; A47J 33/00; A23V 2002/00; B65D 81/3484; A23L 13/03

(57) ABSTRACT

A portable wild game cooker is provided. The cooker utilizes a FRH heating element, a pre-packaged seasoning pouch and a cooking sleeve to provide for immediate cooking of wild game after a wild game harvest event. The cooker allows for fast, clean, and safe cooking of wild game with minimal mess and without the need for cumbersome cooking hardware. The wild game cooker enhances the overall experience of the outdoor enthusiast.

### FIELD OF THE INVENTION

The present invention relates to a wild game cooker. The cooker provides efficient, sanitary, and delicious meals for hunters, fishermen, and outdoor enthusiasts. The wild game cooker allows for the immediate treating and processing of raw game while still in the field. The cooker is flameless and does not require cumbersome cooking hardware such as pans, spatulas, turning forks, and other items normally used in cooking raw game. The field of the invention encompasses field-ready cooking devices for raw game.

### BACKGROUND OF THE INVENTION

In the United States, hunting and fishing are extremely popular outdoor activities. Most anglers and hunters go outdoors for multiple reasons. Although a common perception is that outdoor enthusiasts hunt or fish primarily to bring home dinner, there are other factors at play, including the ability to unwind in the outdoors, to experience nature in its raw form, and to socially interact with other like-minded people. Whatever the reasons, hunters and anglers take immense satisfaction in successfully hauling in big game, small game, and fish. One thing that would increase the satisfaction of a successful hunting or angling experience is having the ability to immediately process the catch for consumption while still in the field. The ability to simply and efficiently process wild game for immediate consumption while still in the field would enhance the overall outdoor experience regardless of the primary motivation for engaging in the sport. Social interactions, appreciation for nature, and the ability to relax in the outdoors are all promoted through the use of the field-ready wild game cooker of the present invention.

There are numerous devices in the cooking arts that provide for instant cooking, flameless reheating of processed foods, and ready-made meals for hiking and other outdoor activities. These prior art devices are cumbersome, require unwieldy pots and cooking utensils, and generally detract from efficient and simple processing of fresh game. For example, U.S. Pat. No. 4,762,056 to Virag discloses a combined package and cooking container that is useful for long-term storage of meals. The Virag cooking device provides for the selective addition of spices, gravies, and food additives by removing certain sealing elements that are in communication with the central cooking pot. Overall, the device is complex and requires more than minimal cooking facilities for processing the food. Another prior art device, disclosed in U.S. Pat. No. 5,220,909 to Pickard and Trottier, teaches of a self-heating individual meal module. The device includes an electrolytic-solution-activated exothermic-chemical pad and a pouch containing an electrolytic solution. The user pulls a tab separating the chemical elements and thereby initiates the exothermic heating process. Although this device is useful for field rations for military personnel and the like, it is inapplicable to a fresh-catch situation where a hunter or angler desires immediate processing of acquired game. Another disclosure, U.S. Pat. No. 6,896,919 to Wright, teaches a cooking pouch for raw or partially cooked proteins, blanched vegetables, and sauces. The differing ingredients are partially pre-cooked and then sealed in the pouch so that a single heating is all that is required to complete the meal preparation. The Wright invention is directed to the processing of frozen food dinners. Yet another disclosure is U.S. Pat. No. 8,490,615 to Cudnohoske and Vacca. This invention is directed to heated field rations and assemblies. These inventors disclose a reheating device that has a complicated array of trays, vents, and exhaust ports that are designed to efficiently warm up food rations in the field.

There exists a need in the art for a wild game cooker that allows immediate cooking of freshly killed fish or game with minimal labor and food preparation. There further exists a need in the art for a field cooker that provides delicious meals with no adverse environmental impact or threat from open fires, fire rings, and unsightly used fire pits. There exists yet another need in the art for a wild game cooker that enhances the overall outdoor enthusiast's experience through immediate cooking of fresh catch without the need for pans, cooking utensils, and other cumbersome articles of traditional meal preparation.

### BRIEF DESCRIPTION OF THE DRAWINGS

FIG. 1 illustrates a front view of the elements of the wild game cooker of the present invention.

FIG. 2 illustrates a break-away view of the wild game cooker of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures.

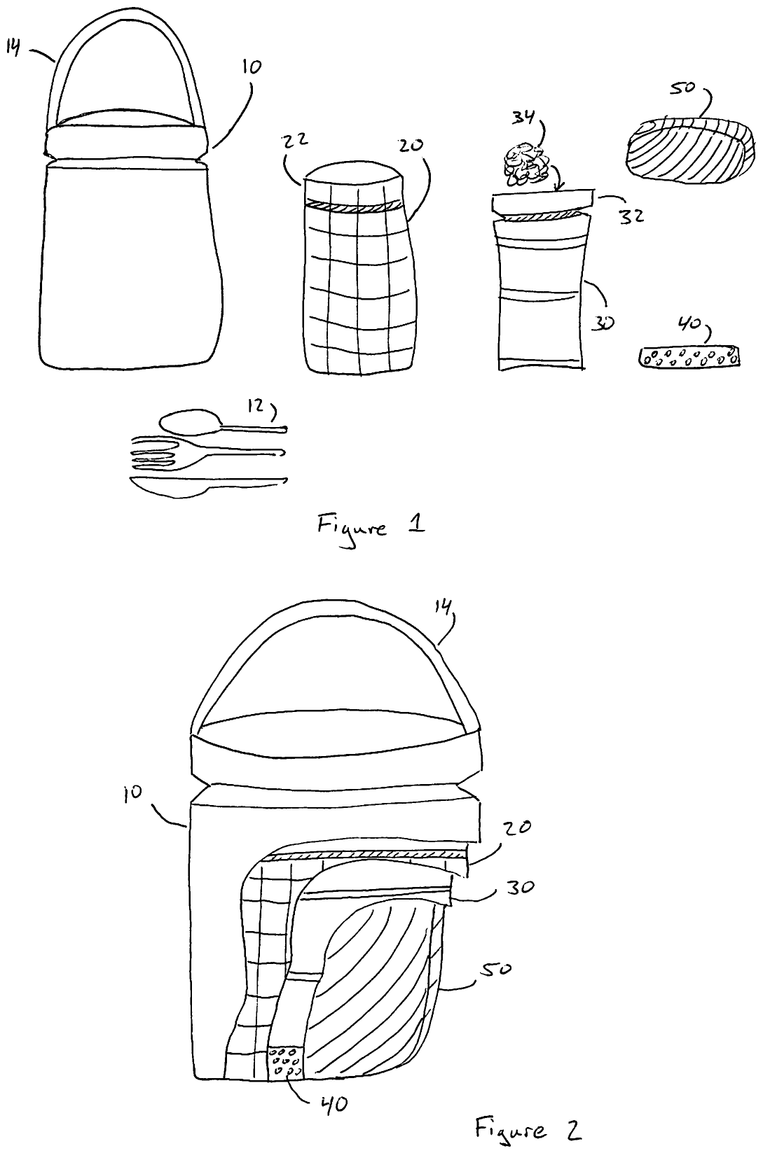

The present invention provides a wild game cooker for preparing delicious and convenient meals immediately after a fresh catch or kill of fish or game. Referring to FIGS. 1 and 2, there is a carrying pouch (10), cooking sleeve (20), seasoning pouch (30), and heating element (40). Carrying pouch (10) can be any type of pouch or bag sized to hold cooking sleeve (20), seasoning pouch (30), heating element (40), and any other desired accessories for the wild game cooker, including eating utensils (12). Carrying pouch (10) is preferably a foil stand-up pouch with an easy tear line and a smooth, full-seal zipper. In one embodiment of the present invention, carrying pouch (10) may optionally comprise a strap (14) for ease of carrying and transporting. In yet another preferred embodiment, carrying pouch (10) is formed of insulating material to trap heat generated from the exothermic reaction of heating element (40) and added water, as explained below in more detail.

Cooking sleeve (20) is an insulated container used to house the fresh game and seasoning mixture during the cooking process. Like carrying pouch (10), cooking sleeve (20) may be a foil stand-up pouch but it is also contemplated in the present invention that the cooking sleeve can by any type of container that is sealable and insulating. As shown in the figures, cooking sleeve (20) has a sealable portion (22) that is used to close off the sleeve once the heating reaction is triggered. In a preferred embodiment of the invention, there is a fill-line (not shown) located on the inside of cooking sleeve (20) to indicate an optimum water level for efficient processing of the fresh game.

Under the present disclosure, it may be cost-effective to select materials for carrying pouch (10) and cooking sleeve (20) that have mutually additive coefficients of insulation such that total heat loss is minimized while not requiring an overly expensive material for cooking sleeve (20) and a non-insulating material for carrying pouch (10). In a preferred embodiment of the invention, the insulating coefficient of cooking sleeve (20) is of sufficient value that the sleeve can be handled without gloves and such that it may not be necessary to use carrying pouch (10) for additional insulating function. However, the present invention also contemplates using a combined insulation effect from both cooking sleeve (20) and carrying pouch (10) such that carrying pouch (10) can be handled with bare hands after inserting cooking sleeve (20) following activation of the heating element.

The wild game cooker further comprises seasoning pouch (30), which performs two functions. The first function is to provide a pre-mixed combination of seasoning, spices, dried gravies, and cooking garnishes (34) for coating the raw, fresh game (50). In this manner, the outdoor enthusiast can easily add cut pieces of fish or game to seasoning pouch (30) for complete salting of the meat with the desired pre-determined flavors. In one embodiment of the invention, seasoning pouch (30) has a sealable end (32) and is presealed with desired seasoning (34). With this feature, the hunter opens presealed seasoning pouch (30), inserts freshly cut meat (50), and then reseals the pouch using sealable end (32). The hunter can then vigorously shake seasoning pouch (30) to thoroughly coat fresh cut meat (50).

The second function of seasoning pouch (30) is to provide a semi-permanent barrier between seasoned meat (50) and the surrounding water poured into cooking sleeve (20). As the cooking temperatures may exceed 100° F. above the ambient temperature and just above the boiling point of water, up to 220° F. and above, seasoning pouch (30) must be formed from a material sufficiently resilient that it can withstand tearing and deconstruction during the cooking process.

Heating element (40) is a flameless ration heater commonly known in the industry as an “FRH.” It comprises a finely powdered magnesium metal alloyed with iron suspended in an electrolyte. Heating element (40) can be formed of soft powder but is preferably hard-pressed into a defined shaped. In a preferred embodiment of the present invention, heating element (40) is hard-pressed into a solid form that can be conveniently placed in a bottom portion of cooking sleeve (20). Water is added to heating element (40), thereby initiating a process known in the art as a supercorroding galvanic cell reaction, where the water dissolves the electrolyte, usually common table salt, forming an electrolytic solution. Upon suspension in the electrolytic solution, the magnesium and iron particles form a galvanic cell that is exothermic during the ensuing oxidation-reduction reaction of the magnesium. Reference is made to U.S. Pat. No. 4,264,362 to Sergev et al., which details the chemical reactions involved in the standard FRH reaction. The reaction produces extreme heat with no flame.

The process of using the present wild game cooker will now be explained. The angler or hunter first prepares the fresh catch to make a clean filet or cut of meat. The meat is placed inside seasoning pouch (30) and the pouch is sealed. The hunter then shakes the pouch to evenly distribute seasoning (34) on the outer surfaces of meat (50). If seasoning (34) includes dried gravies or gravy mixes, the present invention contemplates that the natural moisture from fresh meat (50) will liquefy said dried gravies or gravy mixes without the need for adding any water to seasoning pouch (30). The hunter then places the sealed seasoning pouch (30) and heating element (40) into cooking sleeve (20) and adds water to the cooking sleeve. Cooking sleeve (20) can then be either placed on the ground or, optionally, placed inside carrying pouch (10). After waiting 10-15 minutes, the hunter then opens cooking sleeve (20), removes seasoning pouch (30), and retrieves the now cooked meat (50).

In a preferred embodiment of the invention, carrying pouch (10), cooking sleeve (20), and seasoning pouch (30) are all collapsible such that they can be easily compressed and packed out after use. There may also be provided a hot pad element (not shown) such that cooking sleeve (20) and/or carrying pouch (10) can be placed on the hot pad element after activation of heating element (40). In this manner, the wild game cooker of the present invention can be utilized in open fields, forests, and even on boats without concern for open flames and the risk of fire.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A disposable wild game cooker comprising:
a closeable cooking sleeve configured for holding hot water during a cooking process;
a predetermined amount of flavoring ingredients;
a resilient flavoring pouch having a sealable opening and being configured for holding said flavoring ingredients and a piece of wild game, and being further sized for insertion into said cooking sleeve after being loaded with said flavoring ingredients and wild game; and
a heating element configured for placement inside said cooking sleeve and outside said flavoring pouch.

2. The wild game cooker of claim 1 wherein said heating element is a flameless ration heater.

3. The wild game cooker of claim 2 wherein said cooking sleeve is configured as a freestanding pouch.

4. The wild game cooker of claim 2 wherein said flavoring pouch is configured a s a freestanding pouch.

5. The wild game cooker of claim 4 wherein the additive insulation coefficient of said cooking sleeve and said flavoring pouch is sufficient for a user to handle with bare hands said cooking sleeve during a cooking process.

6. The wild game cooker of claim 5 wherein said heating element is provided in solid form prior to initiation of the cooking process.

7. The wild game cooker of claim 1 further comprising a sealable carrying pouch with a handle.

8. The wild game cooker of claim 7 wherein said heating element is a flameless ration heater.

9. The wild game cooker of claim 8 wherein said cooking sleeve is configured as a freestanding pouch.

10. The wild game cooker of claim 8 wherein said flavoring pouch is configured a s a freestanding pouch.

11. The wild game cooker of claim 10 wherein the additive insulation coefficient of said cooking sleeve and said flavoring pouch is sufficient for a user to handle with bare hands said cooking sleeve during a cooking process.

12. The wild game cooker of claim 11 wherein said heating element is provided in solid form prior to initiation of the cooking process.

13. A method of cooking wild game in the field comprising the steps of:
coating a piece of wild game with a predetermined amount of flavoring ingredients;
enclosing said coated wild game and said flavoring ingredients in a resilient flavoring pouch;
providing a flameless heat source external to said flavoring pouch;
inserting said flavoring pouch and said flameless heat source into a closeable cooking sleeve;
activating said flameless heat source within said cooking sleeve; and
closing said cooking sleeve for a time sufficient to ensure said wild game is cooked.
